(19) United States
(12) Patent Application Publication
(10) Pub. No.: US 2013/0180644 A1
(43) Pub. Date: Jul. 18, 2013

(54) METHOD AND TOOL FOR INTRODUCING A DECORATIVE SEAM

(71) Applicants: Andreas Meyer, Hatzenbuhl (DE); Maxime Musy, Karlsruhe (DE)

(72) Inventors: Andreas Meyer, Hatzenbuhl (DE); Maxime Musy, Karlsruhe (DE)

(73) Assignee: Faurecia Innenraum Systeme GmbH, Hagenbach (DE)

(21) Appl. No.: 13/549,435

(22) Filed: Jul. 14, 2012

(30) Foreign Application Priority Data
Jul. 15, 2011 (DE) 10 2011 107 542.2

(51) Int. Cl. B32B 37/00

(52) U.S. Cl. CPC B32B 37/00
USPC 156/73.1; 156/60; 156/379.6

(57) ABSTRACT

A method and tooling for introducing a decorative seam between two sections of a thermoplastic top layer for a composite part. The method may be carried out using the tooling according to the steps of: forming a contact surface along which a visible side of the first section of the top layer and a visible side of the second section of the top layer are brought into contact; heating the contact surface at least regionally; and at least partially connecting the two sections of the top layer by at least regionally pressing together the two sections along the contact surface using a pressing tool having tooth-like projections.

### TECHNICAL FIELD

The invention relates to a method and to a tool for introducing a decorative seam between two sections of a thermoplastic top layer.

### BACKGROUND

Methods for introducing ornamental seams or decorative seams into layers of thermoplastic material have long been known. Such methods are used e.g. in the manufacture of inner trim parts for motor vehicles. Ornamental seams or decorative seams serve the imitation of functional seams which are used for connecting separate layers. In the present case, the term decorative seam is intended to designate those “seams” which are formed from the material of the layer into which they are introduced. The impression should be created by the introduction of such decorative seams that an article in question is a high-quality, hand-made good.

Ornamental seams are usually introduced into the corresponding layers by means of sewing machines. Such methods are, however, labor-intensive and cost-intensive.

### SUMMARY

It is thus an underlying object of the present invention to develop a method for introducing a decorative seam into a thermoplastic top layer which can be carried out in a simple and inexpensive manner, wherein the decorative seam manufactured by means of the method can imitate a functional seam as much as possible and can thus create the impression of a high-quality and lavishly manufactured product.

This object may be satisfied by a method for introducing a decorative seam between two sections of a thermoplastic top layer for a composite part, wherein the method includes the following steps: forming a contact surface along which a visible side of the first section of the top layer and a visible side of the second section of the top layer are brought into contact; heating the contact surface at least regionally; and at least partly connecting the two sections of the top layer by at least regional pressing together of the two sections along the contact surface using a pressing tool having tooth-like projections.

Since the visible sides of the sections are brought into contact along the contact surface, the contact surface is heated at least regionally, and the sections are pressed together at least regionally along the contact surface by means of the pressing tool having the tooth-like projections, connections are created between the two sections which are formed from a thermoplastic material of the sections and which imitate a functional seam holding the two sections together. The sections for forming the connections along the contact surface are advantageously pressed together where they are heated or are at least partially melted. Since the decorative seam is formed from the thermoplastic material of the top layer itself, no additional material is required for introducing the decorative seam. The decorative seam can thereby be manufactured particularly inexpensively. In addition, the production of the connections by the at least regional heating and pressing together of the sections along the contact surface can be carried out substantially simpler, faster and less expensively than is the case, for example, in methods known from the prior art in which the decorative seam is introduced by means of a sewing machine.

The contact surface can be formed as a fold in the top layer, with the fold then protruding from the top layer at a rear side of the top layer remote from the visible side of the top layer. The contact surface is then provided by an inner region of the fold in which the two sections forming the fold and being arranged at both sides of the fold contacting one another. The fold usually protrudes at or from the rear side of the top layer by a few centimeters, but at least by a few millimeters, at approximately a right angle. The heating is preferably carried out such that the sections are at least partially melted where they are heated so that the connections are formed between the sections. The heating can be performed e.g. by means of a welding unit or by means of an ultrasonic welding gun.

The top layer can be back-foamed with a foamable plastic after the introduction of the decorative seam at the rear side. A foam layer can therefore be introduced at the rear side of the top layer which is usually additionally closed by a carrier at a side of the foam layer remote from the top layer. The contact surface or regions forming the contact surface of the sections then expediently project into the foam layer. The regions of the sections forming the contact surface are then advantageously surrounded by foam at all sides, are embedded in the foam layer and are additionally stabilized in this manner. It is particularly advantageous in this connection that the sections of the top layer are not perforated on the introduction of the decorative seam in accordance with the invention so that the foam cannot move to the visible side of the top layer through any perforation holes on the back-foaming.

So that the introduced decorative seam is easily visible for an observer of the visible side, it is advantageous if the decorative seam is introduced in a region of the sections which directly adjoins the rear side of the top layer. The decorative seam can e.g. be introduced between the sections at most 1 cm, preferably at most 5 mm, below the rear side of the top layer. The decorative seam therefore usually extends at least partially, preferably completely, beneath the visible side of the top layer or even beneath the rear side of the top layer as a rule.

A dividing line which separates the two sections and within which the connections forming the decorative seam are formed between the two sections is typically formed at the visible side by the joining together of the two sections of the top layer. The connections forming the decorative seam then each extend perpendicular to the dividing line. In this case, sewing threads respectively extending perpendicular to the dividing line are therefore imitated by the decorative seam. Viewed from the visible side, the two sections are typically arranged next to one another at either side of the dividing line after the introduction of the decorative seam. The sections are preferably in particular not arranged above one another viewed from the visible side. The sections can therefore abut one another in a plane at the visible side of the top layer. The dividing line can also extend along an edge e.g. of an element projecting into a passenger compartment of a motor vehicle.

The thermoplastic top layer can be manufactured in a rotational sintering process, for example. It is equally conceivable that other molding processes, such as injection molding processes are used for producing the top layer. In the method described here, the decorative seam is typically only embedded into the top layer after the molding of the top layer. The manufacturing process is thereby particularly flexible since the decorative seam can e.g. be introduced at very different points and in very different orientations and lengths in the top layer.

The thermoplastic top layer can in particular be a part of an inner trim part for a passenger compartment of a motor vehicle. The top layer then usually forms that part of the inner trim part which terminates the inner trim part toward the passenger compartment of a vehicle. The top layer can e.g. be a facing of an airbag cover or a cover for a seat cushion.

In an advantageous further embodiment of the invention, the heating and/or the pressing together can be carried out at the rear side of the top layer remote from the visible side. This is in particular favorable when the contact surface is bent over toward the rear side such as in the case that the contact surface is formed from an inner region of a fold in the top layer. Since the visible sides of the sections are brought into contact along the contact surface, the contact surface is particularly easily accessible from the rear side of the top layer.

In a further advantageous embodiment of the invention, a plurality of connection points arranged at regular intervals along a line are formed between the two sections of the top layer by the pressing together in conjunction with the heating of the contact surface. A functional seam is thus simulated such as is produced, for example, with the aid of a sewing machine. The decorative seam introduced in this manner is therefore similar to a functional seam to a high degree. The intervals between the individual connection points preferably amount to less than 1 cm, particularly preferably less than 5 mm. The line along which the connection points are arranged preferably extends parallel to the top layer or to the visible side of the top layer.

In a further advantageous embodiment of the invention, the pressing tool includes a sonotrode of an ultrasonic welding gun. In this respect, the sonotrode is that element with the help of which the ultrasound is introduced into the sections to be connected. The sonotrode is typically formed from a metal such as steel or titanium. The sonotrode is then advantageously equally used for heating and partially melting the first and second sections along the contact surface, with the melting being carried out regionally along the contact surface. The heating or the at least partial melting and the pressing together can in particular be carried out in one workstep with the aid of the sonotrode. The method described here can thus be carried out particularly simply, fast and inexpensively. The projections arranged in a tooth-like manner at a front end of the sonotrode then produce the connections between the first and second sections which form the decorative seam.

A further advantageous embodiment of the invention provides that the sections are additionally adhesively bonded, sewn, welded or clamped together in a further region of the contact surface or along the further region of the contact surface. The further region is in this respect preferably arranged on a side of a part region of the contact surface which is remote from the visible side of the top layer and in which or along which the sections are pressed together. The connection of the two sections gains additional stability in this manner. The connections between the sections forming the decorative seam can in particular be relieved in this manner so that the decorative seam has a particularly long service life. Since the further region is arranged on the side of the part region remote from the visible side, the additional adhesive bonding, sewing, welding or clamping together of the sections in the further region is not visible for a viewer. The additional connection of the sections in the further region is covered by the decorative seam in this case.

In a further advantageous embodiment of the invention, the first section and the second section form mutually adjacent sections of a contiguous part of the top layer. The top layer can equally be formed in multiple parts, with the sections belonging to different parts of the top layer. In this manner, the decorative seam can therefore be introduced both into single-part top layers and into multipart top layers. If the top layer is formed in multiple parts, the different parts of the top layer can in particular have different textures or have different colors at the visible side. An application area of the method of introducing the decorative seam is thereby extended in an advantageous manner.

A tool is furthermore proposed which includes an ultrasonic welding gun having a sonotrode, with the sonotrode having projections which are arranged in a row in the manner of teeth and which are arranged at regular intervals. The previously described method can be carried out particularly simply, fast and inexpensively using such a tool.

The tool is particularly well-suited for manufacturing the decorative seam when the intervals between adjacent projections amount to between 0.5 mm and 1 cm, preferably between 1 mm and 5 mm. A functional seam introduced by means of a sewing machine can be imitated in a manner particularly faithful to the original using a sonotrode designed in this manner.

### BRIEF DESCRIPTION OF THE DRAWINGS

Embodiments of the invention are shown in the drawings and will be explained in more detail by means of the following description. In the drawings:

FIG. 1a shows the forming of a contact surface between two sections of a two-part top layer;

FIG. 1b shows the forming of the contact surface between two sections of a single-part top layer;

FIG. 2 is an ultrasonic welding gun;

FIGS. 3a-d show different embodiments of a sonotrode of the ultrasonic welding gun of FIG. 2;

FIG. 4 is a perspective view of the sonotrode of FIG. 3a;

FIG. 5 shows the introduction of a decorative seam in the contact surface of FIG. 1a;

FIG. 6 shows the introduction of an additional connection in the contact surface of FIG. 5;

FIG. 7 is a perspective representation of the contact surface of FIG. 6; and

FIG. 8 is a perspective view of a decorative seam along the contact surface of FIG. 1a.

### DETAILED DESCRIPTION OF THE ILLUSTRATED EMBODIMENTS

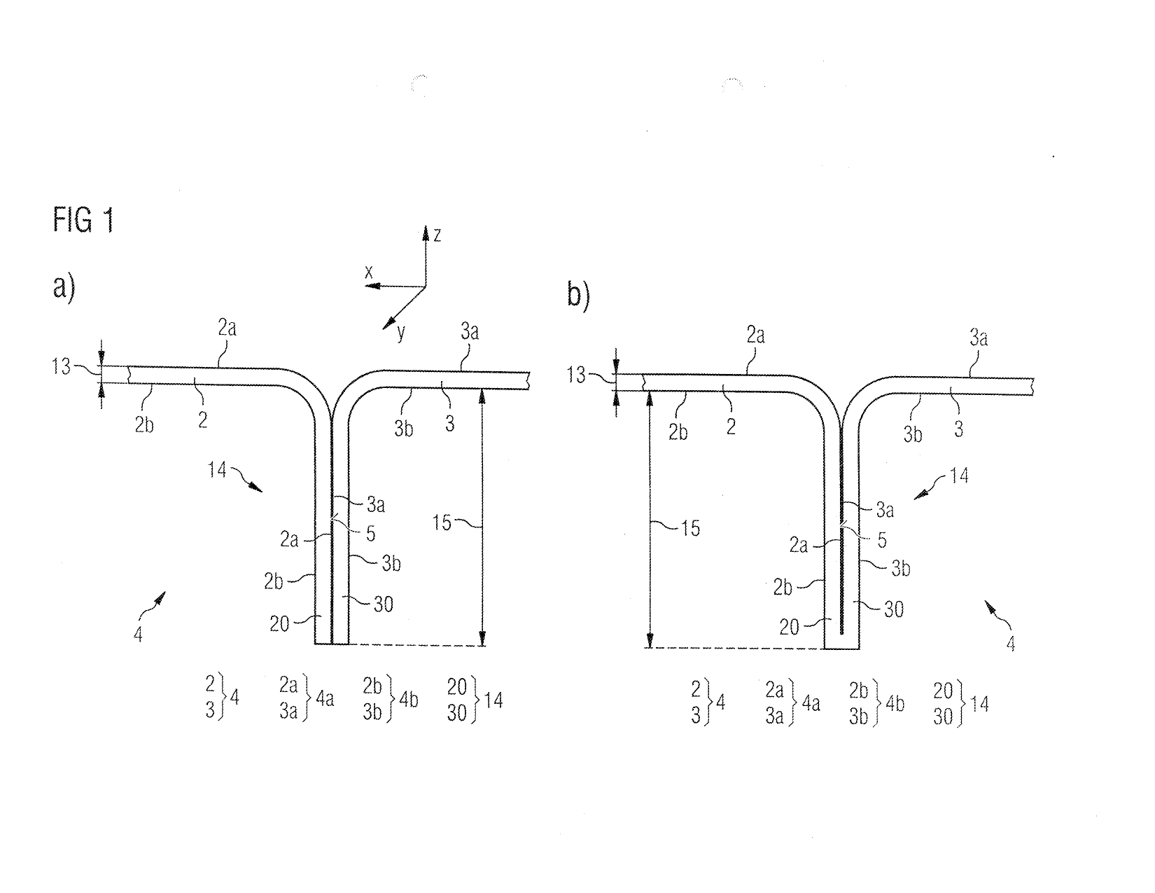

FIGS. 1a and 1b show the formation of a contact surface 5 between a first section 2 and a second section 3 of a thermoplastic top layer 4. The top layer 4 forms a cover of a composite part. In the present case, the composite part is a part of a dashboard for a passenger compartment of a motor vehicle. A visible side 4a of the top layer 4 terminates the top layer toward the inner space of the motor vehicle. A rear side 4b of the top layer 4 forms a side of the top layer 4 remote from the visible side 4a.

In FIG. 1a, the thermoplastic top layer 4, which was manufactured in a rotational sintering process from a polyurethane powder and has a thickness 13 of 2 mm is made in two parts. The first section 2 and the second section 3 of the top layer 4 therefore each belong to separate parts of the top layer 4. Visible sides 2a and 3a of the sections 2 and 3 each form a part of the visible side 4a of the thermoplastic top layer 4. Rear sides 2b and 3b of sections 2 and 3 of the top layer 4 accordingly each form a part of the rear side 4b of the top layer 4. An end 20 of the first section 2 and an end 30 of the second section 3 are each bent over approximately at a right angle and their visible sides 2a and 3a are brought into contact with one another along a contact surface 5. In this manner, the mutually contacting ends 20 and 30 of the sections 2 and 3 form a fold 14 in the top layer 4 which protrudes from the rear side 4b of the top layer 4 at a right angle over a height of around 3 cm.

FIG. 1b shows an alternative embodiment of the contact surface 5 between the sections 2 and 3 of the top layer 4. Here and in the following, recurring features are each provided with identical reference numerals. Unlike the first embodiment of the top layer 4 shown in FIG. 1a, the top layer 4 is formed in one part in FIG. 1b. The first section 2 and the second section 3 of the top layer 4 accordingly form mutually adjacent sections of the single part top layer 4 in FIG. 1b. The visible sides 2a and 3a of the first section 2 and the second section 3 of the top layer 4a are also joined to one another along the contact surface 5 in FIG. 1b. For this purpose, the fold 14 is formed from the end 20 of the first section 2 and from the end 30 of the second section 3, said fold protruding, as in FIG. 1a, approximately at a right angle from the rear side 4b of the top layer 4 over the height 15 of approximately 3 cm. In contrast to FIG. 1a, the respective ends 20 and 30 of the sections 2 and 3 of the top layer 4 are produced from a single piece in FIG. 1b. In FIGS. 1a and 1b, the contact surface 5 extends in a vertical direction—defined by the fold 14—and in a direction perpendicular to the plane of the drawing.

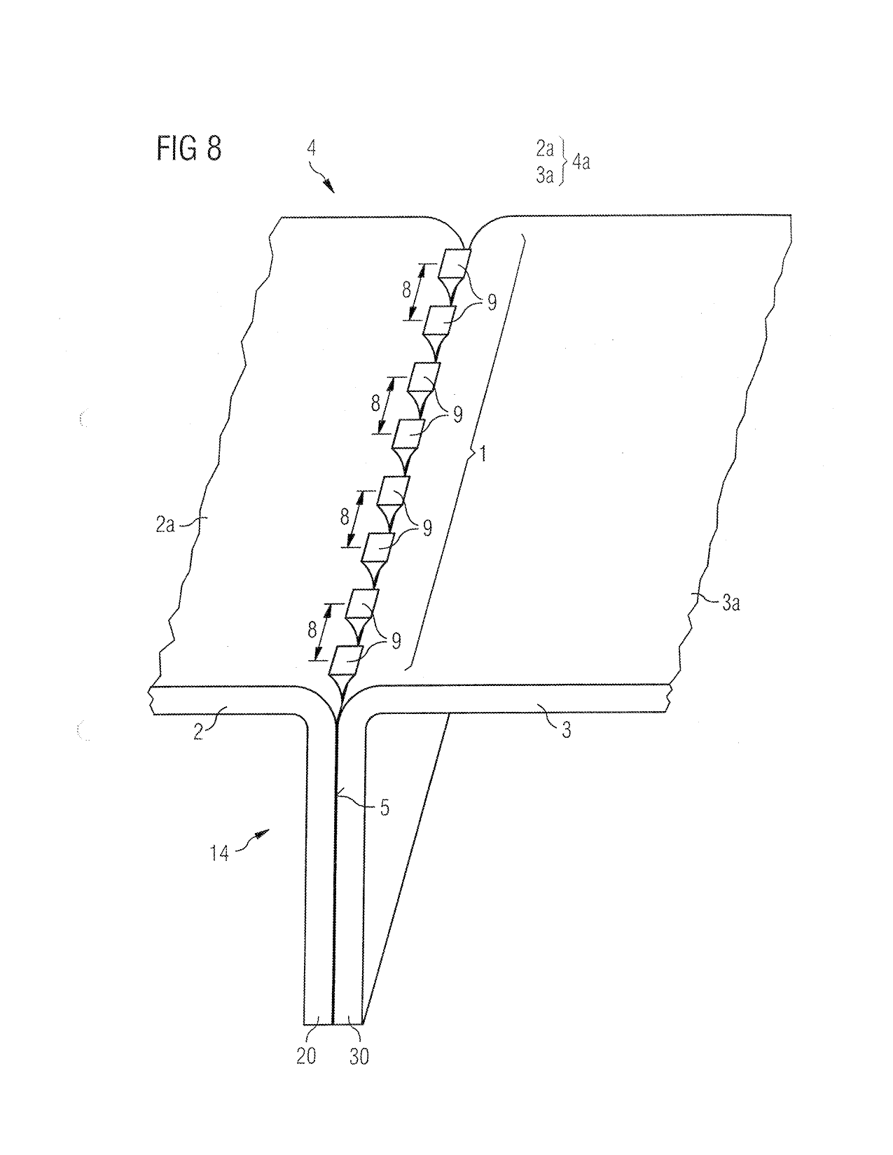

The introduction of a decorative seam 1 (see FIG. 8) in part region 6 of the fold 14, that is between the sections 2 and 3 of the top layer 4, will be described in the following.

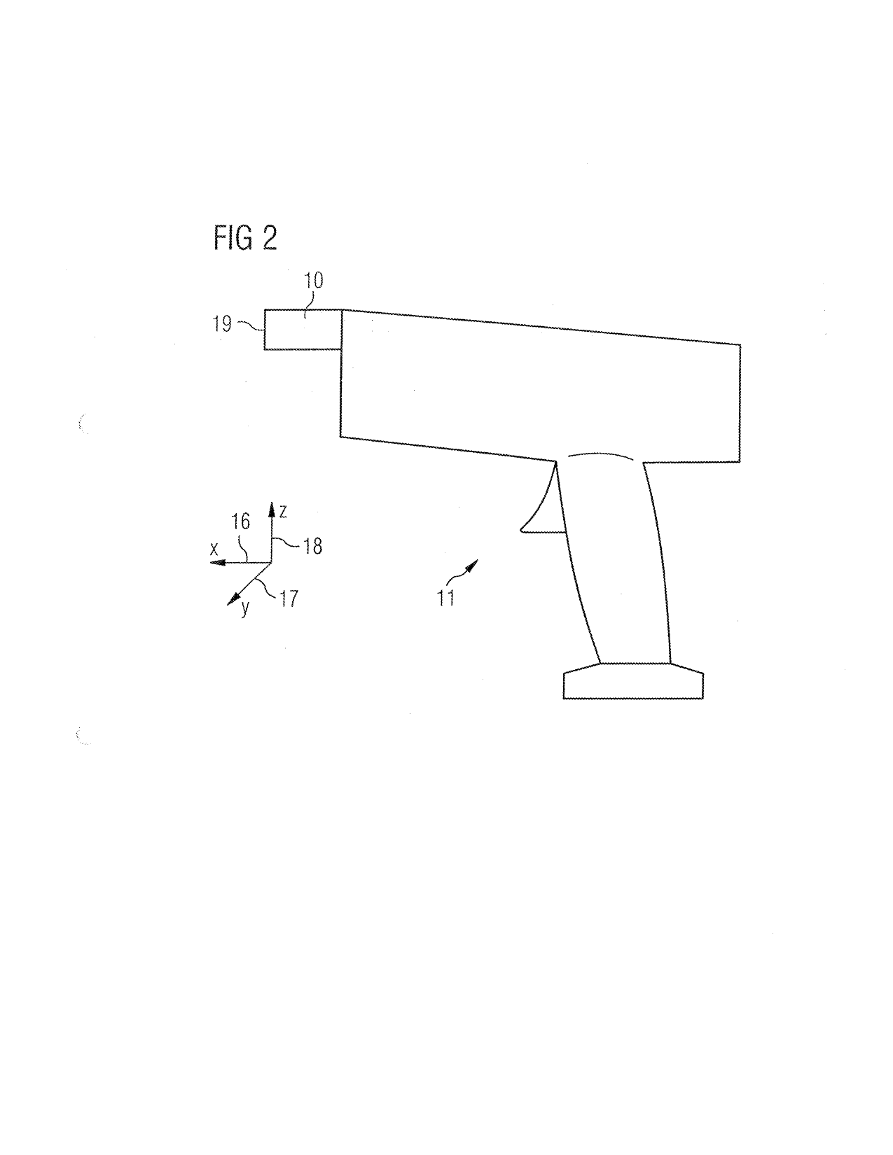

FIG. 2 shows a tool which is used for introducing the decorative seam 1 into the fold 14 of the top layer 4. The tool shown in FIG. 2 is an ultrasonic welding gun 11. The ultrasonic welding gun 11 is configured to introduce ultrasound into the thermoplastic top layer 4 by means of a sonotrode 10 which is made from steel in the present example.

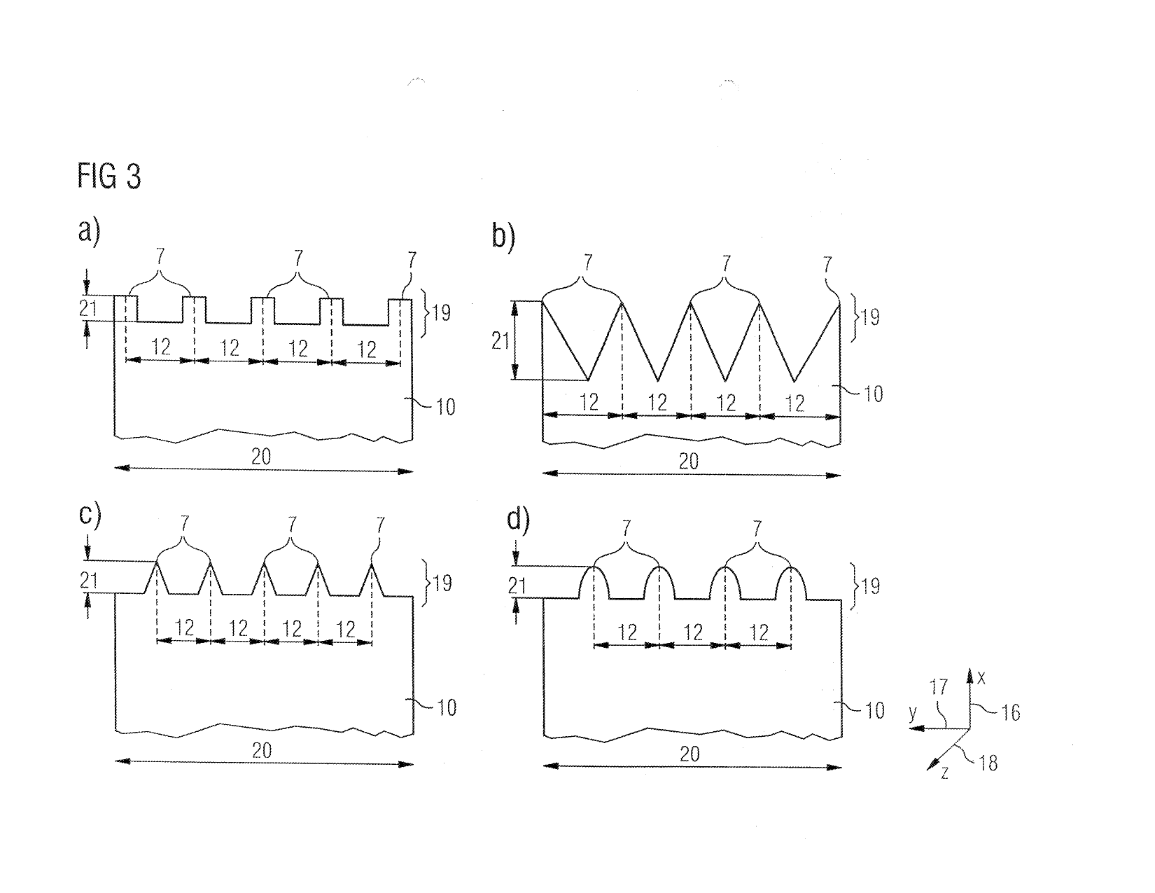

The sonotrode 10 is only shown schematically in FIG. 2. FIGS. 3a to 3d show various embodiments of the sonotrode 10 of the ultrasonic welding gun 11. To illustrate a relative orientation of the sonotrode 10 with respect to the ultrasonic welding gun 11, respective coordinate systems having an X axis 16, a Y axis 17 and a Z axis 18 are shown in FIGS. 2 and 3.

It can be seen from the embodiments of the sonotrode 10 shown in FIGS. 3a to 3d that the sonotrode 10 has respective tooth-like projections 7 at a front end 19. The tooth-like projections 7 are in this respect each arranged in a row at regular intervals 12. The sonotrode 10 therefore has a periodic profile at its front end 19. In this respect, the projections 7 can, for example, be rectangular (FIG. 3a), serrated (FIGS. 3b and 3c) or also rounded (FIG. 3d). In the present example, the sonotrode 10 extends over a length 20 of somewhat less than 3 cm in the Y direction. The intervals 12 between respective adjacent projections 7 in this respect amount to around 5 mm. The values named here for the length 20 of the sonotrode 10 and for the intervals 12 between adjacent projections 7 of the sonotrode 10 are in this respect only intended to have exemplary character. It is thus conceivable that the length 20 of the sonotrode 10 amounts to up to 10 cm or up to 20 cm in the Y direction. In the embodiments of the sonotrode 10 described in FIGS. 3a to 3d, an overhang 21 of the projections 7 at the front end 19 of the sonotrode 10 in each case amounts to around 5 mm. In this respect, the overhang 21 should designate a length of the projections 7 measured in the X direction 16.

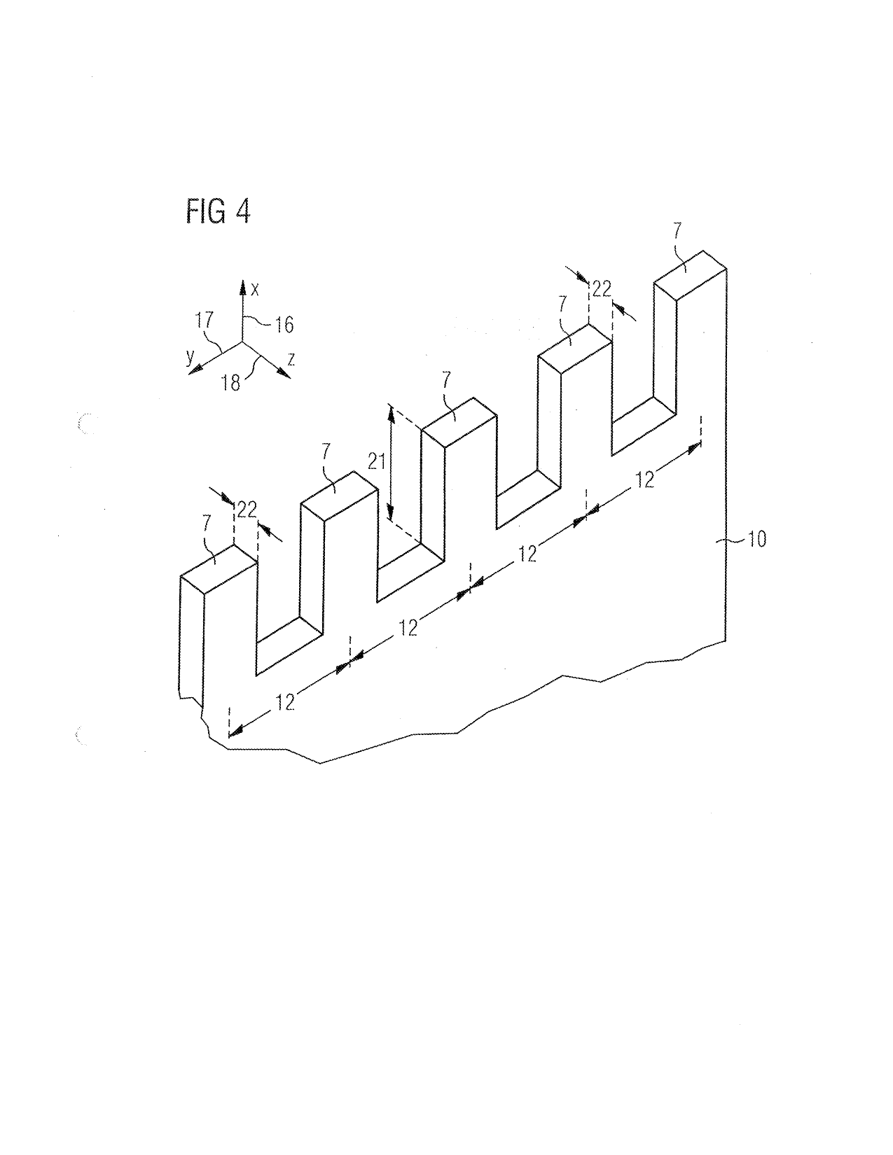

FIG. 4 shows a perspective view of the front end 19 of the sonotrode 10 of FIG. 3a. It can be seen from FIG. 4 that the sonotrode 10 is made as flat and extends over a height 22 of around 3 mm in the Z direction. This value should, however, also only be understood as exemplary. It is thus equally conceivable that the height 22 of the sonotrode 10 amounts to up to some centimeters.

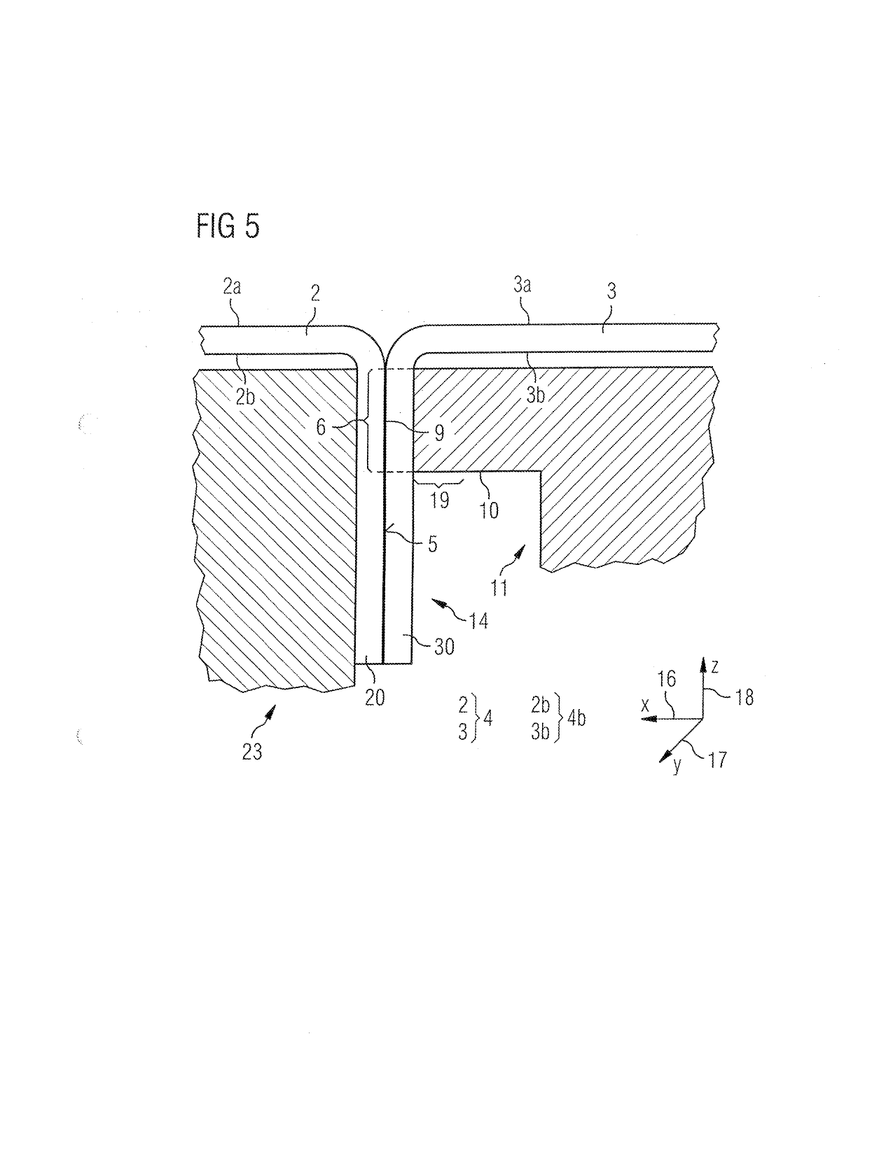

It is shown in FIG. 5 how the decorative seam 1 (see FIG. 8) is introduced into the fold 14 by means of the ultrasonic welding gun 11 at the rear side 4b of the top layer 4 which is composed of the rear sides 3b and 3b of the sections 2 and 3. The introduction of the decorative seam 1 is in this respect only shown with reference to the top layer 4 which has two parts in FIG. 1a. The method steps shown here can naturally be transferred in a directly analog manner to the introduction of a decorative seam into the one-part top layer 4 designed in accordance with FIG. 1a.

The front end 19 of the sonotrode 10 is pressed toward the fold 14 arranged at the rear side 4b of the top layer for introducing the decorative seam 1. The fold 14 is rearwardly supported, i.e. on a side of the fold 14 remote from the sonotrode 10, by a metal block 23 for the partial reception of the pressure exerted onto the fold 14 by the sonotrode 10. The first section 2 and the second section 3 are partially heated and melted along the part region 6 of the contact surface 5 by the introduction of ultrasound by means of the sonotrode 10, and simultaneously urged toward one another by means of the sonotrode 10. The sections 2 and 3 in the part region 6 are melted to one another in this manner. Connections are therefore formed between the sections 2 and 3 of the top layer 4 within the part region 6 along the contact surface 5. The part region 6 is arranged directly beneath the top layer 4 at the rear side 4b.

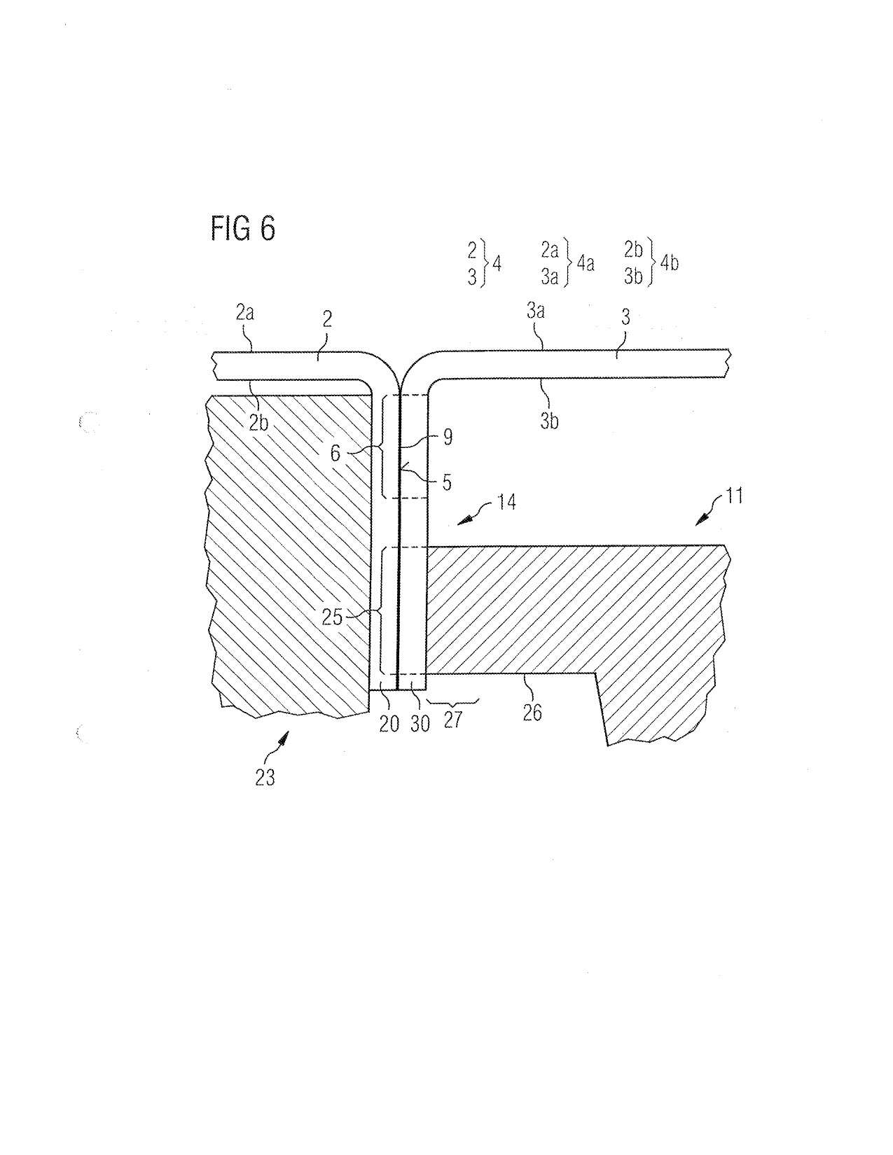

Due to the previously described specific design of the sonotrode 10, a plurality of connections points 9 which are arranged at regular intervals along a line are formed between the sections 2 and 3, in particular between the ends 20 and 30 of the sections 2 and 3 forming the fold 14 (see FIG. 8). The connection points coincide with the part region 6 (see FIG. 6) and are thus arranged directly beneath the top layer 4. An interval between the connection points 9 and the visible side 4a of the top layer amounts, for example, in each case to less than 5 mm. In FIG. 5, the line runs perpendicular to the plane of the drawing, that is along the y axis 17 so that only one of the connection points 9 is indicated. The sonotrode 10 of FIG. 3a is used for forming the connection points 9 in this respect. An arrangement of the x axis 16, of the y axis 17 and of the z axis 18 is selected as in FIGS. 3 and 4. The tooth-like profile at the front side 19 of the sonotrode 10 therefore extends in FIG. 5 along the y axis 17 which is perpendicular to the plane of the drawing so that the individual projections 7 are not visible here.

It is shown in FIG. 6 how the sections 2 and 3, in particular their ends 20 and 30, are additionally connected to one another along a further region 25 of the contact surface 5. The further region 25 is arranged in a lower part of the fold 14 and is thus located at a side of the part region 6 which is remote from the top layer 4 and within which the sections 2 and 3 have previously been regionally melted to one another while forming the connection points 9. In FIG. 6, the sections 2 and 3 of the top layer 4 are likewise connected to one another by ultrasonic welding within the further region 25. In this case, however, a second sonotrode 26 is used which is made as planar at an end piece 27 and does not have any tooth-like projections as the previously used sonotrode 10. Instead of welding the sections 2 and 3 to one another in the further region 25, is it equally easily conceivable to adhesively bond or sew the sections 2 and 3 to one another, or e.g. to clamp them together by means of a clip, in the further region 25.

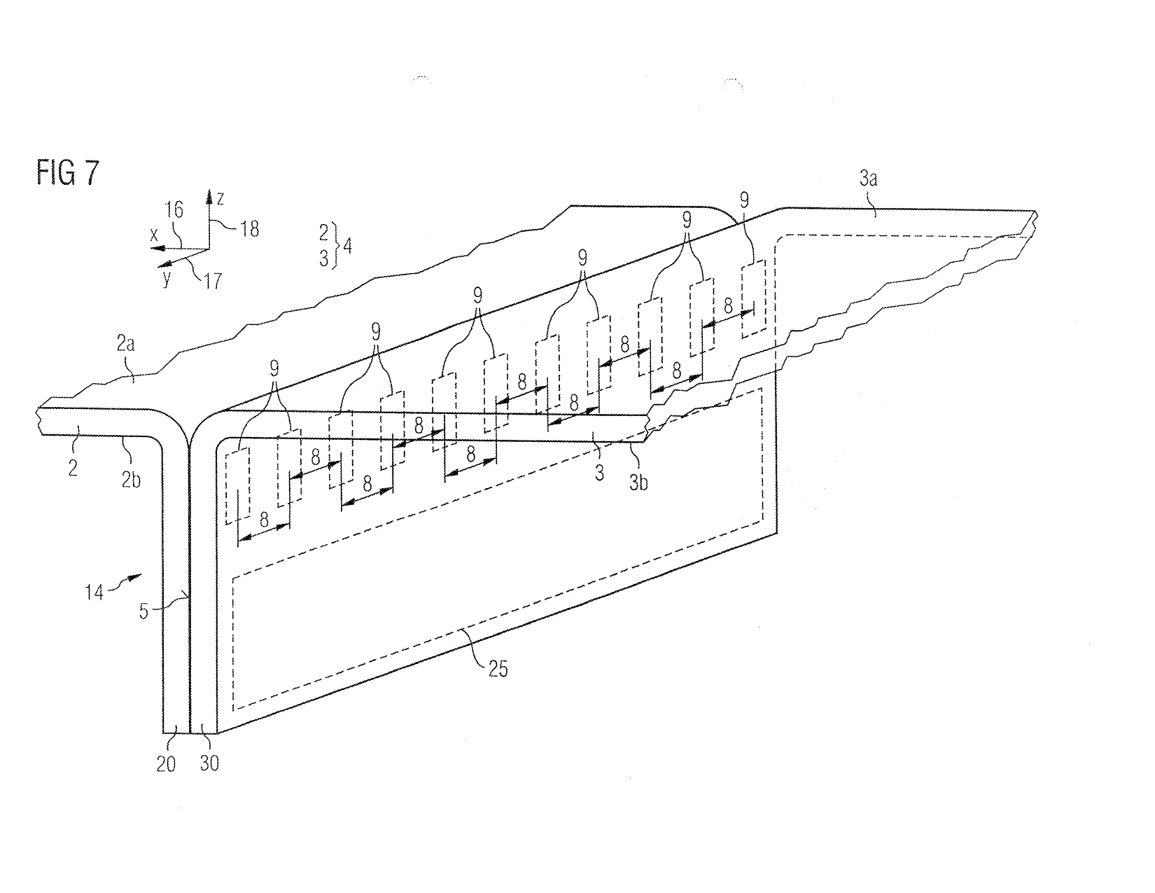

FIG. 7 shows a perspective view of the fold 14 formed from the sections 2 and 3 of the top layer 4. In this respect, the connection points 9, which coincide with the part region 6 (not designated here) of the contact surface 5, and the further region 25 of the contact surface 5 in the interior of the fold 14 are each drawn with dashed lines. Intervals 8 between the connection points 9 correspond to the intervals 12 between the projections 7 of the sonotrode 10 of FIG. 3a which was used to manufacture the connection points 9. The intervals 8 therefore amount to around 5 mm in each case. It can also be clearly recognized here that the further region 25 which gives the connection additional stability between the ends 20 and 30 along the contact surface 5 is arranged on a side of the part region 6 which is remote from the top layer 4 and which here coincides with the connection points 9.

FIG. 8 finally shows the decorative seam 1 such as it is presented to a viewer of the visible side 4a of the top layer 4. The decorative seam 1 is formed from the connection points 9 which are arranged at the regular intervals 8 along a dividing line between the two sections 2 and 3 of the two-part top layer 4. In this respect, the connection points 9 are each formed from material bridges which have been formed along the contact surface 5 in the previously described welding process. The decorative seam 1 therefore simulates a seam connection between the sections 2 and 3 of the top layer 4, with the visible sides 2a and 3a of the sections 2 and 3 merging continuously into one another at either side of the decorative seam 1 and forming the planar visible side 4a of the top layer 4.

1. A method on introducing a decorative seam between two sections of a thermoplastic top layer for a composite part, comprising the steps:
forming a contact surface along which a visible side of the first section of the top layer and a visible side of the second section of the top layer are brought into contact;
heating the contact surface at least regionally; and
at least partially connecting the two sections of the top layer by at least regionally pressing together the two sections along the contact surface using a pressing tool having tooth-like projections.

2. A method in accordance with claim 1, characterized in that the thermoplastic top layer is part of an interior trim part for a passenger compartment of a motor vehicle.

3. A method in accordance with claim 1, characterized in that the heating and/or the pressing together is carried out at a rear side of the top layer remote from the visible side of the top layer.

4. A method in accordance with claim 1, characterized in that a plurality of connection points which are arranged at regular intervals along a line are formed between the sections by the pressing together.

5. A method in accordance with claim 1, characterized in that the pressing tool includes a sonotrode of an ultrasonic welding gun.

6. A method in accordance with claim 5, characterized in that the heating and the pressing together are carried out by means of the sonotrode in one workstep.

7. A method in accordance with claim 5, characterized in that the sections are additionally adhesively bonded, sewn, welded or clamped together in a region of the contact surface which is arranged on a side of connections introduced using the pressing tool remote from the top layer.

8. A method in accordance with claim 1, characterized in that the first section and the second section form mutually adjacent sections of a contiguous part of the top layer; or in that the top layer is made in multiple parts and the sections belong to different parts of the top layer.

9. A tool comprising an ultrasonic welding gun having a sonotrode, wherein the sonotrode has projections which are arranged in a tooth-like manner in a row and which are arranged at regular intervals.

10. A tool in accordance with claim 9, characterized in that the intervals between adjacent projections of the sonotrode amount to between 0.5 mm and 1 cm, preferably between 2 mm and 5 mm.
